(19) United States
(12) Patent Application Publication
(10) Pub. No.: US 2008/0130282 A1
(43) Pub. Date: Jun. 5, 2008

(54) LIGHTING ASSEMBLY AND LIGHTING METHOD

(75) Inventor: Gerald H. NEGLEY, Durham, NC (US)

Correspondence Address: BURR & BROWN, PO BOX 7068, SYRACUSE, NY, 13261-7068, US

(73) Assignee: LED Lighting Fixtures, Inc., Morrisville, NC (US)

(21) Appl. No.: 11/949,222

(22) Filed: Dec. 3, 2007

Related U.S. Application Data
(60) Provisional application No. 60/868,454, filed on Dec. 4, 2006.

(51) Int. Cl. F21V 5/00

(52) U.S. Cl. 362/246

(57) ABSTRACT

There is provided a lighting assembly comprising a plurality of lighting devices, each of which comprises a patterned diffuser having optical features. Each of the lighting devices is positioned such that if they are illuminated, at least 50, and in some cases 75 or more, percent of light emitted from each of the lighting devices will contact an illumination surface within an area of a defined shape (e.g., square, rectangular, hexagonal, octagonal, etc.), the respective shapes each sharing at least one boundary with another shape. Also, methods of lighting comprising illuminating lighting devices positioned in such a way.

### CROSS-REFERENCE TO RELATED APPLICATIONS

This application claims the benefit of U.S. Provisional Patent Application No. 60/868,454, filed Dec. 4, 2006, the entirety of which is incorporated herein by reference.

### FIELD OF THE INVENTION(S)

The present inventive subject matter relates to a lighting assembly, in particular to a lighting assembly which comprises at least one lighting device which comprises optical features. The present inventive subject matter also relates to a lighting method which comprises passing light through a device with optical features.

### BACKGROUND OF THE INVENTION(S)

A large proportion (some estimates are as high as twenty-five percent) of the electricity generated in the United States each year goes to lighting. There is an ongoing need to provide lighting which is more is more energy-efficient and/or which satisfies ever-changing lighting needs.

### BRIEF SUMMARY OF THE INVENTION(S)

According to a first aspect of the present inventive subject matter, there is provided a lighting assembly comprising:

at least first, second, third, fourth and fifth lighting devices, each of the first, second, third, fourth and fifth lighting devices comprising at least one patterned diffuser, each of the patterned diffusers comprising a plurality of optical features,

wherein each of the first, second, third, fourth and fifth lighting devices is positioned relative to each other such that if each of the first, second, third, fourth and fifth lighting devices is and an illumination surface is positioned such that at least a portion of light emitted fi-om each of the first, second, third, fourth and fifth lighting devices travels in a direction substantially perpendicular to the illumination surface:

at least 50, in some cases at least 75, in some cases at least 85, and in some cases at least 90 or 95 percent of light emitted from the first lighting device will contact the illumination surface within a first rectangular area defined by a first line segment, a second line segment, a third line segment and a fourth line segment;

at least 50, in some cases at least 75, in some cases at least 85, and in some cases at least 90 or 95 percent of light emitted from the second lighting device will contact the illumination surface within a second rectangular area defined by the first line segment, a fifth line segment, a sixth line segment and a seventh line segment;

at least 50, in some cases at least 75, in some cases at least 85, and in some cases at least 90 or 95 percent of light emitted from the third lighting device will contact the illumination surface within a third rectangular area defined by the second line segment, an eighth line segment, a ninth line segment and a tenth line segment;

at least 50, in some cases at least 75, in some cases at least 85, and in some cases at least 90 or 95 percent of light emitted from the fourth lighting device will contact the illumination surface within a fourth rectangular area defined by the third line segment, an eleventh line segment, a twelfth line segment and a thirteenth line segment;

at least 50, in some cases at least 75, in some cases at least 85, and in some cases at least 90 or 95 percent of light emitted from the fifth lighting device will contact the illumination surface within a fifth rectangular area defined by the fourth line segment, a fourteenth line segment, a fifteenth line segment and a sixteenth line segment.

Persons of skill in the art are familiar with, and have ready access to, a wide variety of patterned diffusers. Such patterned diffusers are also sometimes referred to as “engineered diffusers.” Any desired patterned diffuser can be employed in the lighting devices and methods of the present inventive subject matter. Such patterned diffusers include optical features, such that a substantial portion, e.g., at least 50%, at least 60%, at least 70%, in some cases at least 80% or at least 90%, and in some cases at least 95% or 99%, of the light which enters the patterned diffuser exits the patterned diffuser within a pattern such that a projected pattern (e.g., a square, a rectangle, a hexagon, an octagon, etc.) of the emitted light would be produced (regardless of the pattern of the light which enters the patterned diffuser) on a structure having a flat surface positioned in the path of the emitted light and substantially perpendicular to the path of the at least a portion of emitted light.

Representative examples of such commercially available patterned diffusers include those marketed by RPC Photonics.

According to a second aspect of the present inventive subject matter, there is provided a lighting assembly comprising:

at least first, second, third, fourth and fifth lighting devices, each of the first, second, third, fourth and fifth lighting devices comprising at least one patterned diffuser, each of the patterned diffusers comprising a plurality of optical features,

wherein each of the first, second, third, fourth and fifth lighting devices is positioned relative to each other such that if each of the first, second, third, fourth and fifth lighting devices is illuminated and an illumination surface is positioned such that at least a portion of light emitted from each of the first, second, third, fourth and fifth lighting devices travels in a direction substantially perpendicular to the illumination surface:

at least 50, in some cases at least 75, in some cases at least 85, and in some cases at least 90 or 95 percent of light emitted from the first lighting device will contact the illumination surface within a first square area defined by a first line segment, a second line segment, a third line segment and a fourth line segment;

at least 50, in some cases at least 75, in some cases at least 85, and in some cases at least 90 or 95 percent of light emitted from the second lighting device will contact the illumination surface within a second square area defined by the first line segment, a fifth line segment, a sixth line segment and a seventh line segment;

at least 50, in some cases at least 75, in some cases at least 85, and in some cases at least 90 or 95 percent of light emitted from the third lighting device will contact the illumination surface within a third square area defined by the second line segment, an eighth line segment, a ninth line segment and a tenth line segment;

at least 50, in some cases at least 75, in some cases at least 85, and in some cases at least 90 or 95 percent of light emitted from the fourth lighting device will contact the illumination surface within a fourth square area defined by the third line segment, an eleventh line segment, a twelfth line segment and a thirteenth line segment;

at least 50, in some cases at least 75, in some cases at least 85, and in some cases at least 90 or 95 percent of light emitted from the fifth lighting device will contact the illumination surface within a fifth square area defined by the fourth line segment, a fourteenth line segment, a fifteenth line segment and a sixteenth line segment.

According to a third aspect of the present inventive subject matter, there is provided a lighting assembly comprising:

at least first, second, third, fourth, fifth, sixth and seventh lighting devices, each of the first, second, third, fourth, fifth, sixth and seventh lighting devices comprising at least one patterned diffuser, each of the patterned diffusers comprising a plurality of optical features,

wherein each of the first, second, third, fourth, fifth, sixth and seventh lighting devices is positioned relative to each other such that if each of the first, second, third, fourth, fifth, sixth and seventh lighting devices is illuminated and an illumination surface is positioned such that at least a portion of light emitted from each of the first, second, third, fourth, fifth, sixth and seventh lighting devices travels in a direction substantially perpendicular to the illumination surface:

at least 50, in some cases at least 75, in some cases at least 85, and in some cases at least 90 or 95 percent of light emitted from the first lighting device will contact the illumination surface within a first hexagonal area defined by a first line segment, a second line segment, a third line segment, a fourth line segment, a fifth line segment and a sixth line segment; at least 50, in some cases at least 75, in some cases at least 85, and in some cases at least 90 or 95 percent of light emitted from the second lighting device will contact the illumination surface within a second hexagonal area defined by the first line segment, a seventh line segment, an eighth line segment, a ninth line segment, a tenth line segment and an eleventh line segment;

at least 50, in some cases at least 75, in some cases at least 85, and in some cases at least 90 or 95 percent of light emitted from the third lighting device will contact the illumination surface within a third hexagonal area defined by the second line segment, a twelfth line segment, a thirteenth line segment, a fourteenth line segment, a fifteenth line segment and a sixteenth line segment;

at least 50, in some cases at least 75, in some cases at least 85, and in some cases at least 90 or 95 percent of light emitted from the fourth lighting device will contact the illumination surface within a fourth hexagonal area defined by the third line segment, a seventeenth line segment, an eighteenth line segment, a nineteenth line segment, a twentieth line segment and a twenty-first line segment;

at least 50, in some cases at least 75, in some cases at least 85, and in some cases at least 90 or 95 percent of light emitted from the fifth lighting device will contact the illumination surface within a fifth hexagonal area defined by the fourth line segment, a twenty-second line segment, a twenty-third line segment, a twenty-fourth line segment, a twenty-fifth line segment and a twenty-sixth line segment;

at least 50, in some cases at least 75, in some cases at least 85, and in some cases at least 90 or 95 percent of light emitted from the sixth lighting device will contact the illumination surface within a sixth hexagonal area defined by the fifth line segment, a twenty-seventh line segment, a twenty-eighth line segment, a twenty-ninth line segment, a thirtieth line segment and a thirty-first line segment;

at least 50, in some cases at least 75, in some cases at least 85, and in some cases at least 90 or 95 percent of light emitted from the seventh lighting device will contact the illumination surface within a seventh hexagonal area defined by the sixth line segment, a thirty-second line segment, a thirty-third line segment, a thirty-fourth line segment, a thirty-fifth line segment and a thirty-sixth line segment.

According to a fourth aspect of the present inventive subject matter, there is provided a lighting assembly comprising:

at least first, second, third, fourth, fifth, sixth, seventh, eighth and ninth lighting devices, each of the first, second, third, fourth, fifth, sixth, seventh, eighth and ninth lighting devices comprising at least one patterned diffuser, each of the patterned diffusers comprising a plurality of optical features,

wherein each of the first, second, third, fourth, fifth, sixth, seventh, eighth and ninth lighting devices is positioned relative to each other such that if each of the first, second, third, fourth, fifth, sixth, seventh, eighth and ninth lighting devices is illuminated and an illumination surface is positioned such that at least a portion of light emitted from each of the first, second, third, fourth, fifth, sixth, seventh, eighth and ninth lighting devices travels in a direction substantially perpendicular to the illumination surface:

at least 50, in some cases at least 75, in some cases at least 85, and in some cases at least 90 or 95 percent of light emitted from the first lighting device will contact the illumination surface within a first octagonal area defined by a first line segment, a second line segment, a third line segment, a fourth line segment, a fifth line segment, a sixth line segment, a seventh line segment and an eighth line segment;

at least 50, in some cases at least 75, in some cases at least 85, and in some cases at least 90 or 95 percent of light emitted from the second lighting device will contact the illumination surface within a first square area defined by the first line segment, a ninth line segment, a tenth line segment and an eleventh line segment; at least 50, in some cases at least 75, in some cases at least 85, and in some cases at least 90 or 95 percent of light emitted from the third lighting device will contact the illumination surface within a second octagonal area defined by the second line segment, a twelfth line segment, a thirteenth line segment, a fourteenth line segment, a fifteenth line segment, a sixteenth line segment, a seventeenth line segment and an eighteenth line segment;

at least 50, in some cases at least 75, in some cases at least 85, and in some cases at least 90 or 95 percent of light emitted from the fourth lighting device will contact the illumination surface within a second square area defined by the third line segment, a nineteenth line segment, a twentieth line segment and a twenty-first line segment;

at least 50, in some cases at least 75, in some cases at least 85, and in some cases at least 90 or 95 percent of light emitted from the fifth lighting device will contact the illumination surface within a third octagonal area defined by the fourth line segment, a twenty-second line segment, a twenty-third line segment, a twenty-fourth line segment, a twenty-fifth line segment, a twenty-sixth line segment, a twenty-seventh line segment and a twenty-eighth line segment;

at least 50, in some cases at least 75, in some cases at least 85, and in some cases at least 90 or 95 percent of light emitted from the sixth lighting device will contact the illumination surface within a third square area defined by the fifth line segment, a twenty-ninth line segment, a thirtieth line segment and a thirty-first line segment;

at least 50, in some cases at least 75, in some cases at least 85, and in some cases at least 90 or 95 percent of light emitted from the seventh lighting device will contact the illumination surface within a fourth octagonal area defined by the sixth line segment, a thirty-second line segment, a thirty-third line segment, a thirty-fourth line segment, a thirty-fifth line segment, a thirty-sixth line segment, a thirty-seventh line segment and a thirty-eighth line segment;

at least 50, in some cases at least 75, in some cases at least 85, and in some cases at least 90 or 95 percent of light emitted from the eighth lighting device will contact the illumination surface within a fourth square area defined by the seventh line segment, a thirty-ninth line segment, a fortieth line segment and a forty-first line segment;

at least 50, in some cases at least 75, in some cases at least 85, and in some cases at least 90 or 95 percent of light emitted from the ninth lighting device will contact the illumination surface within a fifth octagonal area defined by the eighth line segment, a forty-second line segment, a forty-third line segment, a forty-fourth line segment, a forty-fifth line segment, a forty-sixth line segment, a forty-seventh line segment and a forty-eighth line segment.

According to a fifth aspect of the present inventive subject matter, there is provided a method of lighting comprising:

illuminating at least first, second, third, fourth and fifth lighting devices, each of the first, second, third, fourth and fifth lighting devices comprising at least one patterned diffuser, each of the patterned diffusers comprising a plurality of optical features,

wherein each of the first, second, third, fourth and fifth lighting devices is positioned relative to each other such that:

at least 50, in some cases at least 75, in some cases at least 85, and in some cases at least 90 or 95 percent of light emitted from the first lighting device contacts an illumination surface within a first rectangular area defined by a first line segment, a second line segment, a third line segment and a fourth line segment;

at least 50, in some cases at least 75, in some cases at least 85, and in some cases at least 90 or 95 percent of light emitted from the second lighting device contacts the illumination surface within a second rectangular area defined by the first line segment, a fifth line segment, a sixth line segment and a seventh line segment;

at least 50, in some cases at least 75, in some cases at least 85, and in some cases at least 90 or 95 percent of light emitted from the third lighting device contacts the illumination surface within a third rectangular area defined by the second line segment, an eighth line segment, a ninth line segment and a tenth line segment;

at least 50, in some cases at least 75, in some cases at least 85, and in some cases at least 90 or 95 percent of light emitted from the fourth lighting device contacts the illumination surface within a fourth rectangular area defined by the third line segment, an eleventh line segment, a twelfth line segment and a thirteenth line segment;

at least 50, in some cases at least 75, in some cases at least 85, and in some cases at least 90 or 95 percent of light emitted from the fifth lighting device contacts the illumination surface within a fifth rectangular area defined by the fourth line segment, a fourteenth line segment, a fifteenth line segment and a sixteenth line segment.

According to a sixth aspect of the present inventive subject matter, there is provided a method of lighting comprising:

illuminating at least first, second, third, fourth and fifth lighting devices, each of the first, second, third, fourth and fifth lighting devices comprising at least one patterned diffuser, each of the patterned diffusers comprising a plurality of optical features,

wherein each of the first, second, third, fourth and fifth lighting devices is positioned relative to each other such that:

at least 50, in some cases at least 75, in some cases at least 85, and in some cases at least 90 or 95 percent of light emitted from the first lighting device contacts an illumination surface within a first square area defined by a first line segment, a second line segment, a third line segment and a fourth line segment;

at least 50, in some cases at least 75, in some cases at least 85, and in some cases at least 90 or 95 percent of light emitted from the second lighting device contacts the illumination surface within a second square area defined by the first line segment, a fifth line segment, a sixth line segment and a seventh line segment;

at least 50, in some cases at least 75, in some cases at least 85, and in some cases at least 90 or 95 percent of light emitted from the third lighting device contacts the illumination surface within a third square area defined by the second line segment, an eighth line segment, a ninth line segment and a tenth line segment;

at least 50, in some cases at least 75, in some cases at least 85, and in some cases at least 90 or 95 percent of light emitted from the fourth lighting device contacts the illumination surface within a fourth square area defined by the third line segment, an eleventh line segment, a twelfth line segment and a thirteenth line segment;

at least 50, in some cases at least 75, in some cases at least 85, and in some cases at least 90 or 95 percent of light emitted from the fifth lighting device contacts the illumination surface within a fifth square area defined by the fourth line segment, a fourteenth line segment, a fifteenth line segment and a sixteenth line segment.

According to a seventh aspect of the present inventive subject matter, there is provided a method of lighting comprising:

illuminating at least first, second, third, fourth, fifth, sixth and seventh lighting devices, each of the first, second, third, fourth, fifth, sixth and seventh lighting devices comprising at least one patterned diffuser, each of the patterned diffusers comprising a plurality of optical features,

wherein each of the first, second, third, fourth, fifth, sixth and seventh lighting devices is positioned relative to each other such that:

at least 50, in some cases at least 75, in some cases at least 85, and in some cases at least 90 or 95 percent of light emitted from the first lighting device contacts an illumination surface within a first hexagonal area defined by a first line segment, a second line segment, a third line segment, a fourth line segment, a fifth line segment and a sixth line segment;

at least 50, in some cases at least 75, in some cases at least 85, and in some cases at least 90 or 95 percent of light emitted from the second lighting device contacts the illumination surface within a second hexagonal area defined by the first line segment, a seventh line segment, an eighth line segment, a ninth line segment, a tenth line segment and an eleventh line segment;

at least 50, in some cases at least 75, in some cases at least 85, and in some cases at least 90 or 95 percent of light emitted from the third lighting device contacts the illumination surface within a third hexagonal area defined by the second line segment, a twelfth line segment, a thirteenth line segment, a fourteenth line segment, a fifteenth line segment and a sixteenth line segment;

at least 50, in some cases at least 75, in some cases at least 85, and in some cases at least 90 or 95 percent of light emitted from the fourth lighting device contacts the illumination surface within a fourth hexagonal area defined by the third line segment, a seventeenth line segment, an eighteenth line segment, a nineteenth line segment, a twentieth line segment and a twenty-first line segment;

at least 50, in some cases at least 75, in some cases at least 85, and in some cases at least 90 or 95 percent of light emitted from the fifth lighting device contacts the illumination surface within a fifth hexagonal area defined by the fourth line segment, a twenty-second line segment, a twenty-third line segment, a twenty-fourth line segment, a twenty-fifth line segment and a twenty-sixth line segment;

at least 50, in some cases at least 75, in some cases at least 85, and in some cases at least 90 or 95 percent of light emitted from the sixth lighting device contacts the illumination surface within a sixth hexagonal area defined by the fifth line segment, a twenty-seventh line segment, a twenty-eighth line segment, a twenty-ninth line segment, a thirtieth line segment and a thirty-first line segment;

at least 50, in some cases at least 75, in some cases at least 85, and in some cases at least 90 or 95 percent of light emitted from the seventh lighting device contacts the illumination surface within a seventh hexagonal area defined by the sixth line segment, a thirty-second line segment, a thirty-third line segment, a thirty-fourth line segment, a thirty-fifth line segment and a thirty-sixth line segment.

According to an eighth aspect of the present inventive subject matter, there is provided a method of lighting comprising:

illuminating at least first, second, third, fourth, fifth, sixth, seventh, eighth and ninth lighting devices, each of the first, second, third, fourth, fifth, sixth, seventh, eighth and ninth lighting devices comprising at least one patterned diffuser, each of the patterned diffusers comprising a plurality of optical features,

wherein each of the first, second, third, fourth, fifth, sixth, seventh, eighth and ninth lighting devices is positioned relative to each other such that:

at least 50, in some cases at least 75, in some cases at least 85, and in some cases at least 90 or 95 percent of light emitted from the first lighting device contacts an illumination surface within a first octagonal area defined by a first line segment, a second line segment, a third line segment, a fourth line segment, a fifth line segment, a sixth line segment, a seventh line segment and an eighth line segment;

at least 50, in some cases at least 75, in some cases at least 85, and in some cases at least 90 or 95 percent of light emitted from the second lighting device contacts the illumination surface within a first square area defined by the first line segment, a ninth line segment, a tenth line segment and an eleventh line segment;

at least 50, in some cases at least 75, in some cases at least 85, and in some cases at least 90 or 95 percent of light emitted from the third lighting device contacts the illumination surface within a second octagonal area defined by the second line segment, a twelfth line segment, a thirteenth line segment, a fourteenth line segment, a fifteenth line segment, a sixteenth line segment, a seventeenth line segment and an eighteenth line segment;

at least 50, in some cases at least 75, in some cases at least 85, and in some cases at least 90 or 95 percent of light emitted from the fourth lighting device contacts the illumination surface within a second square area defined by the third line segment, a nineteenth line segment, a twentieth line segment and a twenty-first line segment;

at least 50, in some cases at least 75, in some cases at least 85, and in some cases at least 90 or 95 percent of light emitted from the fifth lighting device contacts the illumination surface within a third octagonal area defined by the fourth line segment, a twenty-second line segment, a twenty-third line segment, a twenty-fourth line segment, a twenty-fifth line segment, a twenty-sixth line segment, a twenty-seventh line segment and a twenty-eighth line segment;

at least 50, in some cases at least 75, in some cases at least 85, and in some cases at least 90 or 95 percent of light emitted from the sixth lighting device contacts the illumination surface within a third square area defined by the fifth line segment, a twenty-ninth line segment, a thirtieth line segment and a thirty-first line segment;

at least 50, in some cases at least 75, in some cases at least 85, and in some cases at least 90 or 95 percent of light emitted from the seventh lighting device contacts the illumination surface within a fourth octagonal area defined by the sixth line segment, a thirty-second line segment, a thirty-third line segment, a thirty-fourth line segment, a thirty-fifth line segment, a thirty-sixth line segment, a thirty-seventh line segment and a thirty-eighth line segment;

at least 50, in some cases at least 75, in some cases at least 85, and in some cases at least 90 or 95 percent of light emitted from the eighth lighting device contacts the illumination surface within a fourth square area defined by the seventh line segment, a thirty-ninth line segment, a fortieth line segment and a forty-first line segment;

at least 50, in some cases at least 75, in some cases at least 85, and in some cases at least 90 or 95 percent of light emitted from the ninth lighting device contacts the illumination surface within a fifth octagonal area defined by the eighth line segment, a forty-second line segment, a forty-third line segment, a forty-fourth line segment, a forty-fifth line segment, a forty-sixth line segment, a forty-seventh line segment and a forty-eighth line segment.

By providing lighting devices as described above and arranged as described above, the respective areas of a surface illuminated by the respective lighting devices abut one another without a large proportion of the light overlapping into adjacent areas, enabling more uniform illumination of the surface.

In some embodiments according to the present inventive subject matter, at least one of the lighting devices comprises at least one solid state light emitter.

In some embodiments according to the present inventive subject matter, the light emitted by a light source in the first lighting device enters a first patterned diffuser in the first lighting device through a first surface of the first patterned diffuser and exits the first patterned diffuser through a second surface of the first patterned diffuser. In some such embodiments, a plurality of optical features are positioned on the first surface of the first patterned diffuser.

The inventive subject matter may be more fully understood with reference to the accompanying drawings and the following detailed description of the inventive subject matter.

### BRIEF DESCRIPTION OF THE DRAWING FIGURE

FIG. 1 is a sectional view of a first embodiment of a lighting device according to the present inventive subject matter.

### DETAILED DESCRIPTION OF THE INVENTION(S)

The present inventive subject matter now will be described more fully hereinafter with reference to the accompanying drawings, in which embodiments of the inventive subject matter are shown. However, this inventive subject matter should not be construed as limited to the embodiments set forth herein. Rather, these embodiments are provided so that this disclosure will be thorough and complete, and will fully convey the scope of the inventive subject matter to those skilled in the art. Like numbers refer to like elements throughout As used herein the term “and/or” includes any and all combinations of one or more of the associated listed items.

The terminology used herein is for the purpose of describing particular embodiments only and is not intended to be limiting of the inventive subject matter. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

When an element such as a layer, region or substrate is referred to herein as being “on” or extending “onto” another element, it can be directly on or extend directly onto the other element or intervening elements may also be present. In contrast, when an element is referred to herein as being “directly on” or extending “directly onto” another element, there are no intervening elements present. Also, when an element is referred to herein as being “connected” or “coupled” to another element, it can be directly connected or coupled to the other element or intervening elements may be present. In contrast, when an element is referred to herein as being “directly connected” or “directly coupled” to another element, there are no intervening elements present.

Although the terms “first”, “second”, etc. may be used herein to describe various elements, components, regions, layers, sections and/or parameters, these elements, components, regions, layers, sections and/or parameters should not be limited by these terms. These terms are only used to distinguish one element, component, region, layer or section from another region, layer or section. Thus, a first element, component, region, layer or section discussed below could be termed a second element, component, region, layer or section without departing from the teachings of the present inventive subject matter.

Furthermore, relative terms, such as “lower” or “bottom” and “upper” or “top,” may be used herein to describe one element's relationship to another elements as illustrated in the FIGURE. Such relative terms are intended to encompass different orientations of the device in addition to the orientation depicted in the FIGURE. For example, if the device in the FIGURE is turned over, elements described as being on the “lower” side of other elements would then be oriented on “upper” sides of the other elements. The exemplary term “lower”, can therefore, encompass both an orientation of “lower” and “upper,” depending on the particular orientation of the FIGURE. Similarly, if the device in the FIGURE is turned over, elements described as “below” or “beneath” other elements would then be oriented “above” the other elements. The exemplary terms “below” or “beneath” can, therefore, encompass both an orientation of above and below.

The expression “illumination” (or “illuminated”), as used herein when referring to a solid state light emitter, means that at least some current is being supplied to the solid state light emitter to cause the solid state light emitter to emit at least some light. The expression “illuminated” encompasses situations where the solid state light emitter emits light continuously or intermittently at a rate such that a human eye would perceive it as emitting light continuously, or where a plurality of solid state light emitters of the same color or different colors are emitting light intermittently and/or alternatingly (with or without overlap in “on” times) in such a way that a human eye would perceive them as emitting light continuously (and, in cases where different colors are emitted, as a mixture of those colors).

The expression “excited”, as used herein when referring to a lumiphor, means that at least some electromagnetic radiation (e.g., visible light, Uv light or infrared light) is contacting the lumiphor, causing the lumiphor to emit at least some light. The expression “excited” encompasses situations where the lumiphor emits light continuously or , intermittently at a-rate such that a human eye would perceive it as emitting light continuously, or where a plurality of lumiphors of the same color or different colors are emitting light intermittently and/or alternatingly (with or without overlap in “on” times) in such a way that a human eye would perceive them as emitting light continuously (and, in cases where different colors are emitted, as a mixture of those colors).

The expression “lighting device”, as used herein, is not limited, except that it indicates that the device is capable of emitting light. That is, a lighting device can be a device which illuminates an area or volume, e.g., a structure, a swimming pool or spa, a room, a warehouse, an indicator, a road, a parking lot, a vehicle, signage, e.g., road signs, a billboard, a ship, a toy, a mirror, a vessel, an electronic device, a boat, an aircraft, a stadium, a computer, a remote audio device, a remote video device, a cell phone, a tree, a window, an LCD display, a cave, a tunnel, a yard, a lamppost, or a device or array of devices that illuminate an enclosure, or a device that is used for edge or back-lighting (e.g., back light poster, signage, LCD displays), bulb replacements (e.g., for replacing AC incandescent lights, low voltage lights, fluorescent lights, etc.), lights used for outdoor lighting, lights used for security lighting, lights used for exterior residential lighting (wall mounts, post/column mounts), ceiling fixtures/wall sconces, under cabinet lighting, lamps (floor and/or table and/or desk), landscape lighting, track lighting, task lighting, specialty lighting, ceiling fan lighting, archival/art display lighting, high vibration/impact lighting—work lights, etc., mirrors/vanity lighting, or any other light emitting device.

The expression “substantially perpendicular”, as used herein, means that at least 90% of the points in the item which is characterized as being substantially perpendicular to a reference plane or line are located on one of or between a pair of planes (1) which are perpendicular to the reference plane, (2) which are parallel to each other and (3) which are spaced from each other by a distance of not more than 10% of the largest dimension of the structure.

Unless otherwise defined, all terms (including technical and scientific terms) used herein have the same meaning as commonly understood by one of ordinary skill in the art to which this inventive subject matter belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein. It will also be appreciated by those of skill in the art that references to a structure or feature that is disposed “adjacent” another feature may have portions that overlap or underlie the adjacent feature.

As noted above, according to the present inventive subject matter, there are provided lighting assemblies comprising lighting devices which comprise patterned diffusers, as well as methods of lighting comprising illuminating lighting devices which comprise patterned diffusers.

Any desired lighting devices can be employed in accordance with the present inventive subject matter. Persons of skill in the art are aware of, and have ready access to, a wide variety of such lighting devices.

One representative type of lighting device which is suitable for use according to the present inventive subject matter is solid state light emitters. Such solid state light emitters include inorganic and organic light emitters. Examples of types of such light emitters include a wide variety of light emitting diodes (inorganic or organic, including polymer light emitting diodes (PLEDs)), laser diodes, thin film electroluminescent devices, light emitting polymers (LEPs), a variety of each of which are well-known in the art (and therefore it is not necessary to describe in detail such devices, and/or the materials out of which such devices are made).

Where more than one solid state light emitter is employed, the respective light emitters can be similar to one another, different from one another or any combination (i.e., there can be a plurality of solid state light emitters of one type, or one or more solid state light emitters of each of two or more types)

The lighting devices according to the present inventive subject matter can comprise any desired number of solid state emitters. For example, a lighting device according to the present inventive subject matter can include one or more light emitting diodes, 50 or more light emitting diodes, or 100 or more light emitting diodes, etc.

In some embodiments according to the present inventive subject matter, the lighting device farther comprises at least one lumiphor (i.e., luminescence region or luminescent element which comprises at least one luminescent material). The expression “lumiphor”, as used herein, refers to any luminescent element, i.e., any element which includes a luminescent material.

The one or more lumiphors, when provided, can individually be any lumiphor, a wide variety of which are known to those skilled in the art. For example, the one or more luminescent materials in the lumiphor can be selected from among phosphors, scintillators, day glow tapes, inks which glow in the visible spectrum upon illumination with ultraviolet light, etc. The one or more luminescent materials can be down-converting or up-converting, or can include a combination of both types. For example, the first lumiphor can comprise one or more down-converting luminescent materials.

The (or each of the) one or more lumiphor(s) can, if desired, further comprise (or consist essentially of, or consist of) one or more highly transmissive (e.g., transparent or substantially transparent, or somewhat diffuse) binder, e.g., made of epoxy, silicone, glass, metal oxide or any other suitable material (for example, in any given lumiphor comprising one or more binder, one or more phosphor can be dispersed within the one or more binder). In general, the thicker the lumiphor, the lower the weight percentage of the phosphor can be. Representative examples of the weight percentage of phosphor include from about 3.3 weight percent up to about 20 weight percent, although, as indicated above, depending on the overall thickness of the lumiphor, the weight percentage of the phosphor could be generally any value, e.g., from 0.1 weight percent to 100 weight percent (e.g., a lumiphor formed by subjecting pure phosphor to a hot isostatic pressing procedure).

Devices in which a lumiphor is provided can, if desired, further comprise one or more clear encapsulant (comprising, e.g., one or more silicone materials) positioned between the solid state light emitter (e.g., light emitting diode) and the lumiphor.

For example, light emitting diodes and lumiphors which may be used in practicing the present inventive subject matter are described in:

(1) U.S. Patent Application No. 60/753,138, filed on Dec. 22, 2005, entitled “Lighting Device” (inventor: Gerald H. Negley; attorney docket number 931_{—}003 PRO) and U.S. patent application Ser. No. 11/614,180, filed Dec. 21, 2006, the entireties of which are hereby incorporated by reference;

(2) U.S. Patent Application No. 60/794,379, filed on Apr. 24, 2006, entitled “Shifting Spectral Content in LEDs by Spatially Separating Lumiphor Films” (inventors: Gerald H. Negley and Antony Paul van de Ven; attorney docket number 931_{—}006 PRO) and U.S. patent application Ser. No. 11/624,811, filed Jan. 19, 2007, the entireties of which are hereby incorporated by reference;

(3) U.S. Patent Application No. 60/808,702, filed on May 26, 2006, entitled “Lighting Device” (inventors: Gerald H. Negley and Antony Paul van de Ven; attorney docket number 931_{—}009 PRO) and U.S. patent application Ser. No. 11/751,982, filed May 22, 2007, the entireties of which are hereby incorporated by reference;

(4) U.S. Patent Application No. 60/808,925, filed on May 26, 2006, entitled “Solid State Light Emitting Device and Method of Making Same” (inventors: Gerald H. Negley and Neal Hunter; attorney docket number 931_{—}010 PRO) and U.S. patent application Ser. No. 11/753,103, filed May 24, 2007, the entireties of which are hereby incorporated by reference;

(5) U.S. Patent Application No. 60/802,697, filed on May 23, 2006, entitled “Lighting Device and Method of Making” (inventor: Gerald H. Negley; attorney docket number 931_{—}011 PRO) and U.S. patent application Ser. No. 11/751,990, filed May 22. 2007, the entireties of which are hereby incorporated by reference;

(6) U.S. Patent Application No. 60/839,453, filed on Aug. 23, 2006, entitled “LIGHTING DEVICE AND LIGHTING METHOD” (inventors: Antony Paul van de Ven and Gerald H. Negley; attorney docket number 931_{—}034 PRO) and U.S. patent application Ser. No. 11/843,243, filed Aug. 22, 2007, the entireties of which are hereby incorporated by reference;

(7) U.S. Patent Application No. 60/857,305, filed on Nov. 7, 2006, entitled “LIGHTING DEVICE AND LIGHTING METHOD” (inventors: Antony Paul van de Ven and Gerald H. Negley; attorney docket number 931_{—}027 PRO, the entirety of which is hereby incorporated by reference; and

(8) U.S. Patent Application No. 60/851,230, filed on Oct. 12, 2006, entitled “LIGHTING DEVICE AND METHOD OF MAKING SAME” (inventor: Gerald H. Negley; attorney docket number 931_{—}041 PRO, the entirety of which is hereby incorporated by reference.

The lighting devices of the present inventive subject matter can be arranged, mounted and supplied with electricity in any desired manner, and can be mounted on any desired housing or fixture. Skilled artisans are familiar with a wide variety of arrangements, mounting schemes, power supplying apparatuses, housings and fixtures, and any such arrangements, schemes, apparatuses, housings and fixtures can be employed in connection with the present inventive subject matter. The lighting devices of the present inventive subject matter can be electrically connected (or selectively connected) to any desired power source, persons of skill in the art being familiar with a variety of such power sources.

Representative examples of arrangements of sources of visible light, mounting structures, schemes for mounting sources of visible light, apparatus for supplying electricity to sources of visible light, housings for sources of visible light, fixtures for sources of visible light, power supplies for sources of visible light and complete lighting assemblies, all of which are suitable for the lighting devices of the present inventive subject matter, are described in:

(1) U.S. Patent Application No. 60/752,753, filed on Dec. 21, 2005, entitled “Lighting Device” (inventors: Gerald H. Negley, Antony Paul van de Ven and Neal Hunter; attorney docket no. 931_{—}002 PRO) and U.S. patent application Ser. No. 11/613,692, filed Dec. 20, 2006, the entireties of which are hereby incorporated by reference;

(2) U.S. Patent Application No. 60/798,446, filed on May 5, 2006, entitled “Lighting Device” (inventor: Antony Paul van de Ven; attorney docket no. 931_{—}008 PRO) and U.S. patent application Ser. No. 11/743,754, filed May 3, 2007, the entireties of which are hereby incorporated by reference;

(3) U.S. Patent Application No. 60/845,429, filed on Sep. 18, 2006, entitled “LIGHTING DEVICES, LIGHTING ASSEMBLIES, FIXTURES AND METHODS OF USING SAME” (inventor: Antony Paul van de Ven; attorney docket no. 931_{—}019 PRO), and U.S. patent application Ser. No. 11/856,421, filed Sep. 17, 2007, the entireties of which are hereby incorporated by reference;

(4) U.S. Patent Application No. 60/846,222, filed on Sep. 21, 2006, entitled “LIGHTING ASSEMBLIES, METHODS OF INSTALLING SAME, AND METHODS OF REPLACING LIGHTS” (inventors: Antony Paul van de Ven and Gerald H. Negley; attorney docket no. 931_{—}021 PRO), and U.S. patent application Ser. No. 11/859,048, filed Sep. 21, 2007, the entireties of which are hereby incorporated by reference;

(5) U.S. Patent Application No. 60/809,618, filed on May 31, 2006, entitled “LIGHTING DEVICE AND METHOD OF LIGHTING” (inventors: Gerald H. Negley, Antony Paul van de Ven and Thomas G. Coleman; attorney docket no. 931_{—}017 PRO) and U.S. patent application Ser. No. 11/755,153, filed May 30, 2007, the entireties of which are hereby incorporated by reference;

(6) U.S. Patent Application No. 60/858,558, filed on Nov. 13, 2006, entitled “LIGHTING DEVICE, ILLUMINATED ENCLOSURE AND LIGHTING METHODS” (inventor: Gerald H. Negley; attorney docket no. 931_{—}026 PRO), the entirety of which is hereby incorporated by reference.

(7) U.S. Patent Application No. 60/858,881, filed on Nov. 14, 2006, entitled “LIGHT ENGINE ASSEMBLIES” (inventors: Paul Kenneth Pickard and Gary David Trott; attorney docket number 931_{—}036 PRO), the entirety of which is hereby incorporated by reference;

(8) U.S. Patent Application No. 60/859,013, filed on Nov. 14, 2006, entitled “LIGHTING ASSEMBLIES AND COMPONENTS FOR LIGHTING ASSEMBLIES” (inventors: Gary David Trott and Paul Kenneth Pickard; attorney docket number 931_{—}037 PRO) and U.S. patent application Ser. No. 11/736,799, filed Apr. 18, 2007, the entireties of which are hereby incorporated by reference; and

(9) U.S. Patent Application No. 60/853,589, filed on Oct. 23, 2006, entitled “LIGHTING DEVICES AND METHODS OF INSTALLING LIGHT ENGINE HOUSINGS AND/OR TRIM ELEMENTS IN LIGHTING DEVICE HOUSINGS” (inventors: Gary David Trott and Paul Kenneth Pickard; attorney docket number 931_{—}038 PRO), the entirety of which is hereby incorporated by reference.

Persons skilled in the art are familiar with, and have ready access to, a wide variety of optical elements, any of which is suitable for use in the lighting devices according to the present inventive subject matter.

Embodiments in accordance with the present inventive subject matter are described herein with reference to cross-sectional (and/or plan view) illustrations that are schematic illustrations of idealized embodiments of the present inventive subject matter. As such, variations from the shapes of the illustrations as a result, for example, of manufacturing techniques and/or tolerances, are to be expected. Thus, embodiments of the present inventive subject matter should not be construed as limited to the particular shapes of regions illustrated herein but are to include deviations in shapes that result, for example, from manufacturing. For example, a molded region illustrated or described as a rectangle will, typically, have rounded or curved features. Thus, the regions illustrated in the FIGURE are schematic in nature and their shapes are not intended to illustrate the precise shape of a region of a device and are not intended to limit the scope of the present inventive subject matter.

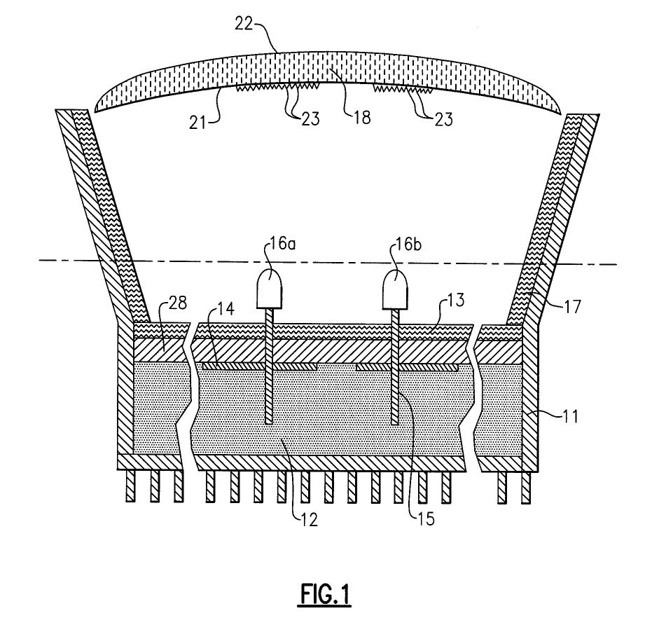

FIG. 1 is a sectional view of a first embodiment of a lighting device according to the present inventive subject matter.

Referring to FIG. 1, there is shown a lighting device which comprises plural solid state lighting devices 16a and 16b (LEDs in this embodiment), a patterned diffuser 18, a heat spreading element 11, insulating regions 12, a highly reflective surface 13, conductive traces 14 formed on a printed circuit board 28, a lead frame 15 and a reflective cone 17. The LEDs 16a and 16b are positioned relative to the patterned diffuser 18 such that if the LEDs 16a and 16b are illuminated so that they emit light, at least some of the light emitted by the LEDs 16a and 16b enters the patterned diffuser 18 through a first surface 21 and exits the patterned diffuser 18 through a second surface 22, the patterned diffuser 18 comprising a plurality of optical features 23 formed on the first surface 21.

Any two or more structural parts of the lighting assemblies described herein can be integrated. Any structural part of the lighting assemblies described herein can be provided in two or more parts which are held together, if necessary. Similarly, any two or more functions can be conducted simultaneously, and/or any function can be conducted in a series of steps.

Furthermore, while certain embodiments of the present inventive subject matter have been illustrated with reference to specific combinations of elements, various other combinations may also be provided without departing from the teachings of the present inventive subject matter. Thus, the present inventive subject matter should not be construed as being limited to the particular exemplary embodiments described herein and illustrated in the FIGURE, but may also encompass combinations of elements of the various illustrated embodiments.

Many alterations and modifications may be made by those having ordinary skill in the art, given the benefit of the present disclosure, without departing from the spirit and scope of the inventive subject matter. Therefore, it must be understood that the illustrated embodiments have been set forth only for the purposes of example, and that it should not be taken as limiting the inventive subject matter as defined by the following claims. The following claims are, therefore, to be read to include not only the combination of elements which are literally set forth but all equivalent elements for performing substantially the same function in substantially the same way to obtain substantially the same result. The claims are thus to be understood to include what is specifically illustrated and described above, what is conceptually equivalent, and also what incorporates the essential idea of the inventive subject matter.

1. A lighting assembly comprising:
at least first, second, third, fourth and fifth lighting devices, each of said first, second, third, fourth and fifth lighting devices comprising at least one patterned diffuser, each of said patterned diffusers comprising a plurality of optical features,
wherein each of said first, second, third, fourth and fifth lighting devices is positioned relative to each other such that if each of said first, second, third, fourth and fifth lighting devices is illuminated and an illumination surface is positioned such that at least a portion of light emitted from each of said first, second, third, fourth and fifth lighting devices travels in a direction substantially perpendicular to said illumination surface:
at least 75 percent of light emitted from said first lighting device will contact said illumination surface within a first rectangular area defined by a first line segment, a second line segment, a third line segment and a fourth line segment;
at least 75 percent of light emitted from said second lighting device will contact said illumination surface within a second rectangular area defined by said first line segment, a fifth line segment, a sixth line segment and a seventh line segment;
at least 75 percent of light emitted from said third lighting device will contact said illumination surface within a third rectangular area defined by said second line segment, an eighth line segment, a ninth line segment and a tenth line segment;
at least 75 percent of light emitted from said fourth lighting device will contact said illumination surface within a fourth rectangular area defined by said third line segment, an eleventh line segment, a twelfth line segment and a thirteenth line segment;
at least 75 percent of light emitted from said fifth lighting device will contact said illumination surface within a fifth rectangular area defined by said fourth line segment, a fourteenth line segment, a fifteenth line segment and a sixteenth line segment.

2. A lighting assembly as recited in claim 1, wherein at least one of said first, second, third, fourth and fifth lighting devices comprises at least one solid state light emitter.

3. A lighting assembly as recited in claim 1, wherein said light emitted by a light source in said first lighting device enters a first patterned diffuser in said first lighting device through a first surface of said first patterned diffuser and exits said first patterned diffuser through a second surface of said first patterned diffuser.

4. A lighting assembly as recited in claim 3, wherein a plurality of optical features are positioned on said first surface of said first patterned diffuser.

5. A lighting assembly comprising:
at least first, second, third, fourth and fifth lighting devices, each of said first, second, third, fourth and fifth lighting devices comprising at least one patterned diffuser, each of said patterned diffusers comprising a plurality of optical features,
wherein each of said first, second, third, fourth and fifth lighting devices is positioned relative to each other such that if each of said first, second, third, fourth and fifth lighting devices is illuminated and an illumination surface is positioned such that at least a portion of light emitted from each of said first, second, third, fourth and fifth lighting devices travels in a direction substantially perpendicular to said illumination surface:
at least 75 percent of light emitted from said first lighting device will contact said illumination surface within a first square area defined by a first line segment, a second line segment, a third line segment and a fourth line segment;
at least 75 percent of light emitted from said second lighting device will contact said illumination surface within a second square area defined by said first line segment, a fifth line segment, a sixth line segment and a seventh line segment;
at least 75 percent of light emitted from said third lighting device will contact said illumination surface within a third square area defined by said second line segment, an eighth line segment, a ninth line segment and a tenth line segment;
at least 75 percent of light emitted from said fourth lighting device will contact said illumination surface within a fourth square area defined by said third line segment, an eleventh line segment, a twelfth line segment and a thirteenth line segment;
at least 75 percent of light emitted from said fifth lighting device will contact said illumination surface within a fifth square area defined by said fourth line segment, a fourteenth line segment, a fifteenth line segment and a sixteenth line segment.

6. A lighting assembly as recited in claim 5, wherein at least one of said first, second, third, fourth and fifth lighting devices comprises at least one solid state light emitter.

7. A lighting assembly as recited in claim 5, wherein said light emitted by a light source in said first lighting device enters a first patterned diffuser in said first lighting device through a first surface of said first patterned diffuser and exits said first patterned diffuser through a second surface of said first patterned diffuser.

8. A lighting assembly as recited in claim 7, wherein a plurality of optical features are positioned on said first surface of said first patterned diffuser.

9. A lighting assembly comprising:
at least first, second, third, fourth, fifth, sixth and seventh lighting devices, each of said first, second, third, fourth, fifth, sixth and seventh lighting devices comprising at least one patterned diffuser, each of said patterned diffusers comprising a plurality of optical features,
wherein each of said first, second, third, fourth, fifth, sixth and seventh lighting devices is positioned relative to each other such that if each of said first, second, third, fourth, fifth, sixth and seventh lighting devices is illuminated and an illumination surface is positioned such that at least a portion of light emitted from each of said first, second, third, fourth, fifth, sixth and seventh lighting devices travels in a direction substantially perpendicular to said illumination surface:
at least 75 percent of light emitted from said first lighting device will contact said illumination surface within a first hexagonal area defined by a first line segment, a second line segment, a third line segment, a fourth line segment, a fifth line segment and a, sixth line segment;
at least 75 percent of light emitted from said second lighting device will contact said illumination surface within a second hexagonal area defined by said first line segment, a seventh line segment, an eighth line segment, a ninth line segment, a tenth line segment and an eleventh line segment;
at least 75 percent of light emitted from said third lighting device will contact said illumination surface within a third hexagonal area defined by said second line segment, a twelfth line segment, a thirteenth line segment, a fourteenth line segment, a fifteenth line segment and a sixteenth line segment;
at least 75 percent of light emitted from said fourth lighting device will contact said illumination surface within a fourth hexagonal area defined by said third line segment, a seventeenth line segment, an eighteenth line segment, a nineteenth line segment, a twentieth line segment and a twenty-first line segment;
at least 75 percent of light emitted from said fifth lighting device will contact said illumination surface within a fifth hexagonal area defined by said fourth line segment, a twenty-second line segment, a twenty-third line segment, a twenty-fourth line segment, a twenty-fifth line segment and a twenty-sixth line segment;
at least 75 percent of light emitted from said sixth lighting device will contact said illumination surface within a sixth hexagonal area defined by said fifth line segment, a twenty-seventh line segment, a twenty-eighth line segment, a twenty-ninth line segment, a thirtieth line segment and a thirty-first line segment;
at least 75 percent of light emitted from said seventh lighting device will contact said illumination surface within a seventh hexagonal area defined by said sixth line segment, a thirty-second line segment, a thirty-third line segment, a thirty-fourth line segment, a thirty-fifth line segment and a thirty-sixth line segment.

10. A lighting assembly as recited in claim 9, wherein at least one of said first, second, third, fourth, fifth, sixth and seventh lighting devices comprises at least one solid state light emitter.

11. A lighting assembly as recited in claim 9, wherein said light emitted by a light source in said first lighting device enters a first patterned diffuser in said first lighting device through a first surface of said first patterned diffuser and exits said first patterned diffuser through a second surface of said first patterned diffuser.

12. A lighting assembly as recited in claim 11, wherein a plurality of optical features are positioned on said first surface of said first patterned diffuser.

13. A lighting assembly comprising:
at least first, second, third, fourth, fifth, sixth, seventh, eighth and ninth lighting devices, each of said first, second, third, fourth, fifth, sixth, seventh, eighth and ninth lighting devices comprising at least one patterned diffuser, each of said patterned diffusers comprising a plurality of optical features,
wherein each of said first, second, third, fourth, fifth, sixth, seventh, eighth and ninth lighting devices is positioned relative to each other such that if each of said first, second, third, fourth, fifth, sixth, seventh, eighth and ninth lighting devices is illuminated and an illumination surface is positioned such that at least a portion of light emitted from each of said first, second, third, fourth, fifth, sixth, seventh, eighth and ninth lighting devices travels in a direction substantially perpendicular to said illumination surface:
at least 75 percent of light emitted from said first lighting device will contact said illumination surface within a first octagonal area defined by a first line segment, a second line segment, a third line segment, a fourth line segment, a fifth line segment, a sixth line segment, a seventh line segment and an eighth line segment;
at least 75 percent of light emitted from said second lighting device will contact said illumination surface within a first square area defined by said first line segment, a ninth line segment, a tenth line segment and an eleventh line segment;
at least 75 percent of light emitted from said third lighting device will contact said illumination surface within a second octagonal area defined by said second line segment, a twelfth line segment, a thirteenth line segment, a fourteenth line segment, a fifteenth line segment, a sixteenth line segment, a seventeenth line segment and an eighteenth line segment;
at least 75 percent of light emitted from said fourth lighting device will contact said illumination surface within a second square area defined by said third line segment, a nineteenth line segment, a twentieth line segment and a twenty-first line segment;
at least 75 percent of light emitted from said fifth lighting device will contact said illumination surface within a third octagonal area defined by said fourth line segment, a twenty-second line segment, a twenty-third line segment, a twenty-fourth line segment, a twenty-fifth line segment, a twenty-sixth line segment, a twenty-seventh line segment and a twenty-eighth line segment;
at least 75 percent of light emitted from said sixth lighting device will contact said illumination surface within a third square area defined by said fifth line segment, a twenty-ninth line segment, a thirtieth line segment and a thirty-first line segment;
at least 75 percent of light emitted from said seventh lighting device will contact said illumination surface within a fourth octagonal area defined by said sixth line segment, a thirty-second line segment, a thirty-third line segment, a thirty-fourth line segment, a thirty-fifth line segment, a thirty-sixth line segment, a thirty-seventh line segment and a thirty-eighth line segment;
at least 75 percent of light emitted from said eighth lighting device will contact said illumination surface within a fourth square area defined by said seventh line segment, a thirty-ninth line segment, a fortieth line segment and a forty-first line segment;
at least 75 percent of light emitted from said ninth lighting device will contact said illumination surface within a fifth octagonal area defined by said eighth line segment, a forty-second line segment, a forty-third line segment, a forty-fourth line segment, a forty-fifth line segment, a forty-sixth line segment, a forty-seventh line segment and a forty-eighth line segment.

14. A lighting assembly as recited in claim 13, wherein at least one of said first, second, third, fourth, fifth, sixth, seventh, eighth and ninth lighting devices comprises at least one solid state light emitter.

15. A lighting assembly as recited in claim 13, wherein said light emitted by a light source in said first lighting device enters a first patterned diffuser in said first lighting device through a first surface of said first patterned diffuser and exits said first patterned diffuser through a second surface of said first patterned diffuser.

16. A lighting assembly as recited in claim 15, wherein a plurality of optical features are positioned on said first surface of said first patterned diffuser.

17. A method of lighting comprising:
illuminating at least first, second, third, fourth and fifth lighting devices, each of said first, second, third, fourth and fifth lighting devices comprising at least one patterned diffuser, each of said patterned diffusers comprising a plurality of optical features,
wherein each of said first, second, third, fourth and fifth lighting devices is positioned relative to each other such that:
at least 75 percent of light emitted from said first lighting device contacts an illumination surface within a first rectangular area defined by a first line segment, a second line segment, a third line segment and a fourth line segment;
at least 75 percent of light emitted from said second lighting device contacts said illumination surface within a second rectangular area defined by said first line segment, a fifth line segment, a sixth line segment and a seventh line segment;
at least 75 percent of light emitted from said third lighting device contacts said illumination surface within a third rectangular area defined by said second line segment, an eighth line segment, a ninth line segment and a tenth line segment;
at least 75 percent of light emitted from said fourth lighting device contacts said illumination surface within a fourth rectangular area defined by said third line segment, an eleventh line segment, a twelfth line segment and a thirteenth line segment;
at least 75 percent of light emitted from said fifth lighting device contacts said illumination surface within a fifth rectangular area defined by said fourth line segment, a fourteenth line segment, a fifteenth line segment and a sixteenth line segment.

18. A method as recited in claim 17, wherein at least one of said first, second, third, fourth and fifth lighting devices comprises at least one solid state light emitter.

19. A method as recited in claim 17, wherein said light emitted by a light source in said first lighting device enters a first patterned diffuser in said first lighting device through a first surface of said first patterned diffuser and exits said first patterned diffuser through a second surface of said first patterned diffuser.

20. A method as recited in claim 19, wherein a plurality of optical features are positioned on said first surface of said first patterned diffuser.

21. A method of lighting comprising:
illuminating at least first, second, third, fourth and fifth lighting devices, each of said first, second, third, fourth and fifth lighting devices comprising at least one patterned diffuser, each of said patterned diffusers comprising a plurality of optical features,
wherein each of said first, second, third, fourth and fifth lighting devices is positioned relative to each other such that:
at least 75 percent of light emitted from said first lighting device contacts an illumination surface within a first square area defined by a first line segment, a second line segment, a third line segment and a fourth line segment;
at least 75 percent of light emitted from said second lighting device contacts said illumination surface within a second square area defined by said first line segment, a fifth line segment, a sixth line segment and a seventh line segment;
at least 75 percent of light emitted from said third lighting device contacts said illumination surface within a third square area defined by said second line segment, an eighth line segment, a ninth line segment and a tenth line segment;
at least 75 percent of light emitted from said fourth lighting device contacts said illumination surface within a fourth square area defined by said third line segment, an eleventh line segment, a twelfth line segment and a thirteenth line segment;
at least 75 percent of light emitted from said fifth lighting device contacts said illumination surface within a fifth square area defined by said fourth line segment, a fourteenth line segment, a fifteenth line segment and a sixteenth line segment.

22. A method as recited in claim 21, wherein at least one of said first, second, third, fourth and fifth lighting devices comprises at least one solid state light emitter.

23. A method as recited in claim 21, wherein said light emitted by a light source in said first lighting device enters a first patterned diffuser in said first lighting device through a first surface of said first patterned diffuser and exits said first patterned diffuser through a second surface of said first patterned diffuser.

24. A method as recited in claim 23, wherein a plurality of optical features are positioned on said first surface of said first patterned diffuser.

25. A method of lighting comprising:
illuminating at least first, second, third, fourth, fifth, sixth and seventh lighting devices, each of said first, second, third, fourth, fifth, sixth and seventh lighting devices comprising at least one patterned diffuser, each of said patterned diffusers comprising a plurality of optical features,
wherein each of said first, second, third, fourth, fifth, sixth and seventh lighting devices is positioned relative to each other such that:
at least 75 percent of light emitted from said first lighting device contacts an illumination surface within a first hexagonal area defined by a first line segment, a second line segment, a third line segment, a fourth line segment, a fifth line segment and a sixth line segment;
at least 75 percent of light emitted from said second lighting device contacts said illumination surface within a second hexagonal area defined by said first line segment, a seventh line segment, an eighth line segment, a ninth line segment, a tenth line segment and an eleventh line segment;
at least 75 percent of light emitted from said third lighting device contacts said illumination surface within a third hexagonal area defined by said second line segment, a twelfth line segment, a thirteenth line segment, a fourteenth line segment, a fifteenth line segment and a sixteenth line segment;
at least 75 percent of light emitted from said fourth lighting device contacts said illumination surface within a fourth hexagonal area defined by said third line segment, a seventeenth line segment, an eighteenth line segment, a nineteenth line segment, a twentieth line segment and a twenty-first line segment;
at least 75 percent of light emitted from said fifth lighting device contacts said illumination surface within a fifth hexagonal area defined by said fourth line segment, a twenty-second line segment, a twenty-third line segment, a twenty-fourth line segment, a twenty-fifth line segment and a twenty-sixth line segment;
at least 75 percent of light emitted from said sixth lighting device contacts said illumination surface within a sixth hexagonal area defined by said fifth line segment, a twenty-seventh line segment, a twenty-eighth line segment, a twenty-ninth line segment, a thirtieth line segment and a thirty-first line segment;
at least 75 percent of light emitted from said seventh lighting device contacts said illumination surface within a seventh hexagonal area defined by said sixth line segment, a thirty-second line segment, a thirty-third line segment, a thirty-fourth line segment, a thirty-fifth line segment and a thirty-sixth line segment.

26. A method as recited in claim 25, wherein at least one of said first, second, third, fourth, fifth, sixth and seventh lighting devices comprises at least one solid state light emitter.

27. A method as recited in claim 25, wherein said light emitted by a light source in said first lighting device enters a first patterned diffuser in said first lighting device through a first surface of said first patterned diffuser and exits said first patterned diffuser through a second surface of said first patterned diffuser.

28. A method as recited in claim 27, wherein a plurality of optical features are positioned on said first surface of said first patterned diffuser.

29. A method of lighting comprising:
illuminating at least first, second, third, fourth, fifth, sixth, seventh, eighth and ninth lighting devices, each of said first, second, third, fourth, fifth, sixth, seventh, eighth and ninth lighting devices comprising at least one patterned diffuser, each of said patterned diffusers comprising a plurality of optical features,
wherein each of said first, second, third, fourth, fifth, sixth, seventh, eighth and ninth lighting devices is positioned relative to each other such that:
at least 75 percent of light emitted from said first lighting device contacts an illumination surface within a first octagonal area defined by a first line segment, a second line segment, a third line segment, a fourth line segment, a fifth line segment, a sixth line segment, a seventh line segment and an eighth line segment;
at least 75 percent of light emitted from said second lighting device contacts said illumination surface within a first square area defined by said first line segment, a ninth line segment, a tenth line segment and an eleventh line segment;
at least 75 percent of light emitted from said third lighting device contacts said illumination surface within a second octagonal area defined by said second line segment, a twelfth line segment, a thirteenth line segment, a fourteenth line segment, a fifteenth line segment, a sixteenth line segment, a seventeenth line segment and an eighteenth line segment;
at least 75 percent of light emitted from said fourth lighting device contacts said illumination surface within a second square area defined by said third line segment, a nineteenth line segment, a twentieth line segment and a twenty-first line segment;
at least 75 percent of light emitted from said fifth lighting device contacts said illumination surface within a third octagonal area defined by said fourth line segment, a twenty-second line segment, a twenty-third line segment, a twenty-fourth line segment, a twenty-fifth line segment, a twenty-sixth line segment, a twenty-seventh line segment and a twenty-eighth line segment;
at least 75 percent of light emitted from said sixth lighting device contacts said illumination surface within a third square area defined by said fifth line segment, a twenty-ninth line segment, a thirtieth line segment and a thirty-first line segment;
at least 75 percent of light emitted from said seventh lighting device contacts said illumination surface within a fourth octagonal area defined by said sixth line segment, a thirty-second line segment, a thirty-third line segment, a thirty-fourth line segment, a thirty-fifth line segment, a thirty-sixth line segment, a thirty-seventh line segment and a thirty-eighth line segment;
at least 75 percent of light emitted from said eighth lighting device contacts said illumination surface within a fourth square area defined by said seventh line segment, a thirty-ninth line segment, a fortieth line segment and a forty-first line segment;
at least 75 percent of light emitted from said ninth lighting device contacts said illumination surface within a fifth octagonal area defined by said eighth line segment, a forty-second line segment, a forty-third line segment, a forty-fourth line segment, a forty-fifth line segment, a forty-sixth line segment, a forty-seventh line segment and a forty-eighth line segment.

30. A method as recited in claim 29, wherein at least one of said first, second, third, fourth, fifth, sixth, seventh, eighth and ninth lighting devices comprises at least one solid state light emitter.

31. A method as recited in claim 29, wherein said light emitted by a light source in said first lighting device enters a first patterned diffuser in said first lighting device through a first surface of said first patterned diffuser and exits said first patterned diffuser through a second surface of said first patterned diffuser.

32. A method as recited in claim 31, wherein a plurality of optical features are positioned on said first surface of said first patterned diffuser.
